(19) United States
(12) Patent Application Publication
(10) Pub. No.: US 2011/0285519 A1
(43) Pub. Date: Nov. 24, 2011

(54) Static Officer Proximity Alert System

(76) Inventor: Kurt Scheuermann, Parker, CO (US)

(21) Appl. No.: 13/110,369

(22) Filed: May 18, 2011

Related U.S. Application Data
(60) Provisional application No. 61/347,181, filed on May 21, 2010.

(51) Int. Cl. B60Q 1/00

(52) U.S. Cl. 340/425.5

(57) ABSTRACT

An architecture is presented that provides a system of sensors and other components that allow law enforcement officials to continuously monitor the exterior perimeter of his or her stationary vehicle for approaching attackers. The system affords 360 degree surveillance and protection and is capable of alerting the vehicle's occupants and remote users of the system of an impending attack.

### CROSS-REFERENCE

This application claims priority from Provisional Patent Application Ser. No. 61/347,181 filed May 21, 2010.

### BACKGROUND

Police officers and law enforcement officials spend considerable amounts of time in stationary vehicles writing reports, monitoring traffic and public safety, completing computer work, and fulfilling other similar duties, both during the day and during the nighttime. Unfortunately, there are many blind spots associated with said vehicles that interfere with a police officer's ability to monitor his or her surroundings while sitting in a stationary vehicle, particularly at night. Moreover, the problem is compounded by the fact that the officer is oftentimes required to complete a number of ministerial tasks such as writing and reviewing reports, dialoguing with a dispatcher, completing computer work and the like while sitting in the stationary vehicle, which can further distract the officer from being able to continuously monitor his or her surroundings.

Because of the forgoing, it is relatively easy for an intruder or attacker to sneak up on an officer in a stationary vehicle and conduct a surprise attack. If the officer or law enforcement official is unaware of his or her surroundings, and does not have enough time to react to a surprise attack, the officer or law enforcement official may be seriously injured or killed.

Consequently, a long felt need exists in the art for a static officer proximity alert system that permits an officer or law enforcement official to continuously monitor the perimeter of his or her stationary or relatively slow moving vehicle during both the daytime and the nighttime. A need also exists for a static officer proximity alert system that alerts the officer if anyone or anything approaches the perimeter of the vehicle, thereby providing the officer with additional time in which to react to the potential or actual threat. Finally, a need exists within the art for a static office proximity alert system that is also capable of triggering an array of lights, sounds and/or alarms to ward off or startle potential intruders and/or attackers and possibly thwart the attack.

As described more fully herein, the static officer proximity alert system of the present invention utilizes and improves upon prior art proximity alerts systems, such as those used to detect the presence of an object behind a vehicle when the vehicle is traveling in reverse, to satisfy all of the forgoing long felt needs associated with stationary or static police or law enforcement vehicles and to provide a safer and more efficient working environment for police officers and law enforcement officials who are positioned in stationary or relatively slow moving vehicles.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a static officer proximity alert (“SOPA”) system that is designed to protect officers and law enforcement officials from possible ambushes and attacks when they are positioned in stationary or relatively slow moving vehicles and unaware of an approaching intruder or attacker. The SOPA system is capable of, among other things: (i) detecting the presence, activity or movement of an object or a person, such as an attacker, as the object or person approaches the vehicle from any direction; (ii) alerting the occupants of the vehicle, and other remote users of the system such as police dispatch, of the approaching object or person and their location in relationship to the vehicle; and (iii) automatically activating the vehicle's overhead strobe, take down, head, tail and alleys lights, or horn and the like, to thwart the attack and/or startle the attacker to provide the occupants with a tactical advantage.

More specifically, in the preferred embodiment of the present invention, the SOPA system comprises a plurality of proximity sensors located on the exterior of a police or law enforcement vehicle and operable to sense an object or person's presence or activity within a threshold distance from the vehicle; an information display viewable by the occupants of the vehicle and operable to alert said occupants of the presence or movement of an object or person within said threshold distance; and a control which is operable to generate an alert to the occupants of the vehicle that an object or person is within said threshold distance and the location of said object or person in relationship to the vehicle, and to trigger exterior indicia, such as a warning, to said object or person within said threshold distance, all in response to a signal from one or more of said proximity sensors.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates an elevational view of a law enforcement vehicle with the sensors of the SOPA system applied to the exterior of the vehicle.

FIG. 2 illustrates a perspective view of one embodiment of the control and information display illustrating the various sensors and zones of the vehicle being monitored by the SOPA system.

FIG. 3 illustrates a perspective view of a law enforcement vehicle with the SOPA system activated in the background. For visibility purposes, FIG. 3 does not show a law enforcement officer occupying the vehicle.

FIG. 3A illustrates a close-up perspective view of the SOPA system depicted in FIG. 3.

FIG. 4 illustrates a perspective view of the sensors of the SOPA system being activated by the intruder approaching the rear portion of the vehicle, thereby alerting the vehicle's occupants (not shown for clarity purposes) and causing the vehicle's various lights and horn to activate.

FIG. 5 illustrates a perspective view of the startled intruder running away from the law enforcement vehicle after being startled by the vehicle's lights and horn.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

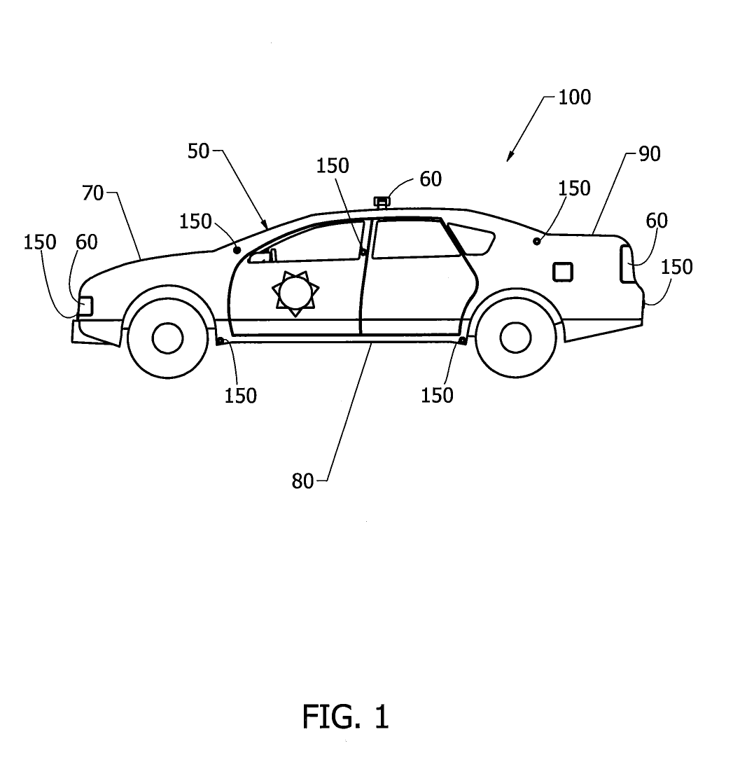

Referring now specifically to the drawings and the illustrative embodiments depicted therein, FIG. 1 depicts a law enforcement vehicle 50 equipped with the SOPA or proximity alert system 100 of the present invention. Vehicle 50 further comprises lights 60, a front portion 70, side portions 80, a rear portion 90, and a horn (not shown). Vehicle 50, lights 60 and horn (not shown) are well-known in the art and, except as otherwise stated herein, can be of any type commonly used in association with law enforcement activities and vehicles. For example, lights 60 are capable of being turned on and off, blinking, flashing, strobe effect, etc.

Proximity alert system 100 is preferably comprised of a plurality of sensors 150, control device 300, and an information display 400 for, among other purposes, monitoring the perimeter of a law enforcement vehicle. Sensors 150 are well known in the art, such as those sensors currently utilized in vehicles as reverse parking sensors and the like. More specifically, sensors 150 can be any sensor capable of detecting an object's presence or movement within a specified area or within a threshold distance, as measured from sensor 150, such as, for example, infrared motion sensors, sound wave sensors, accelerometers or any other type of sensor currently known in the art. In a preferred embodiment of the present invention, sensor 150 would be capable of detecting an object or person's presence, activity or movement within a threshold distance or radius of ten feet from sensor 150, though it is also contemplated that the sensitivity of sensor 150 can be adjusted to increase or decrease the threshold distance in the manner described below without affecting the overall concept of the present invention.

Sensors 150 are preferably located on the exterior surface of vehicle 50 in spaced apart fashion as depicted in FIG. 1 including, without limitation, front portion 70, side portions 80 and rear portion 90. More specifically, sensors 150 can be installed almost anywhere on vehicle 50, but are preferably installed on vehicle 50 in sufficient number and location so as to be capable of detecting the presence, movement and/or activity of an object or person within a threshold distance of vehicle 50 in any direction, as best illustrated in FIG. 1. Sensors 150 can be virtually any color though it is preferred that the color of sensors 150 match the color of the exterior of vehicle 50 so as to make sensors 150 generally inconspicuous. It is also contemplated that sensors 150 can be manufactured or embedded within the exterior components of vehicle 50, such as in the fender, windows, bumpers and the like.

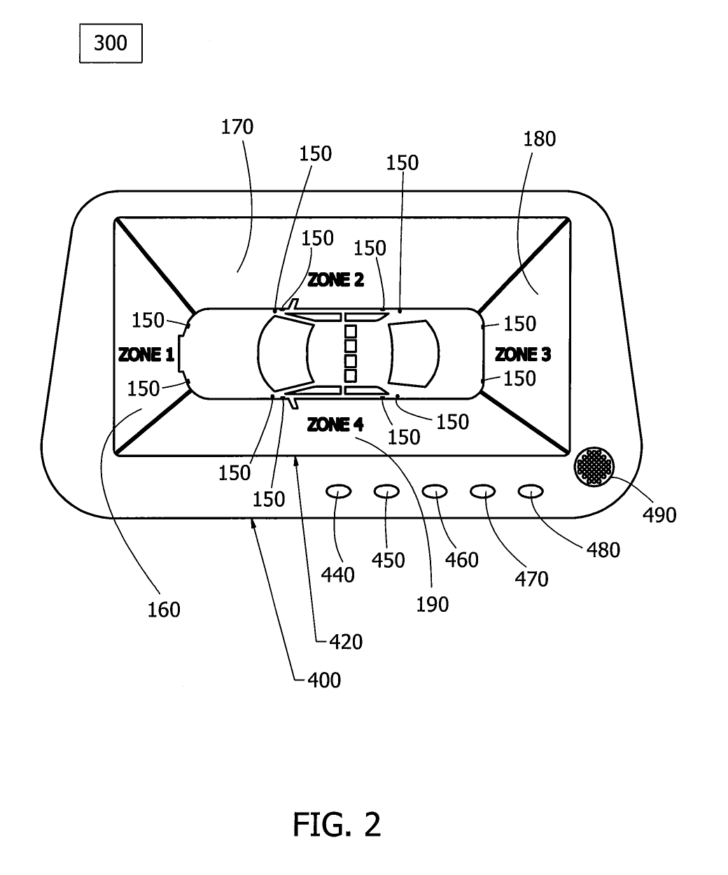

In a preferred embodiment of the present invention, sensors 150 are located on vehicle 50 in the manner depicted in FIG. 2 so as to create a plurality of zones (160, 170, 180, 190) around the perimeter of vehicle 50 that can be monitored by proximity alert system 100 as described more fully below.

Control device 300 is preferably a computer or other central processing unit of a type commonly known in the art that is in electronic communication with each of sensors 150, and capable of receiving and processing a signal (not shown) received from any of sensors 150, and sending a corresponding signal (not shown) to information display device 400 or a remote user (not shown) as described more fully below. The communications between sensors 150, control device 300 and information display 400 is known in the art and can, for example, function similar to the communication mechanisms currently deployed in vehicles having reverse parking sensors in which a sensor on the rear of the moving vehicle communicates with the cabin of the vehicle to alert the driver that an object is behind the vehicle. Similarly, the communication between control device 300 and a remote user (not shown) may function in a manner similar to existing OnStar® technology.

Control device 300 can also be connected to the vehicle's electrical system (not shown) such that, upon receiving a signal from any of sensors 150, control device 300 can activate one or more of lights 60 and/or horn (not shown) of vehicle 50 in any desired manner to assist in startling the intruder and potentially thwarting the impending attack as described more fully below.

In the preferred embodiment of the present invention, information display 400 is comprised of a screen 420, power button 440, a sensor/zone select button 450, a first sensor sensitivity button 460, a second sensor sensitivity button 470, an alarm mute button 480 and an alarm 490. Information display 400 may also include a number of other controls commonly associated with said devices including, without limitation, volume control (not shown), brightness control (not shown) and contrast adjustment (not shown).

More specifically, power button 440 can be used to turn proximity alert system 100 on or off. Sensor/zone select button 450 can be used to activate or deactivate any particular sensor 150 or any particular zone 160, 170, 180, 190. For example, an officer in vehicle 50 that is facing traffic may wish to deactivate zone 160 so as to avoid activation of proximity alert system 100 due to the continuous movement of traffic within the threshold distance in front of vehicle 50.

First sensor sensitivity button 460 can be used to increase the sensitivity of a particular sensor(s) 150, and second sensor sensitivity button 470 can be used to decrease the sensitivity of a particular sensor(s) 150. Alarm mute button 480 can be used to turn off the alarm following an activation of proximity alert system 100.

Screen 420 is preferably capable of displaying alphanumerical values and a visual display of vehicle 50, sensors 150 and zones 160, 170, 180 and 190, as best illustrated in FIG. 2. Screen 420 is preferably an emitting display such as a vacuum fluorescent display or a light emitting diode (LED) display, although other display types such as electroluminescent display, a liquid crystal display (LCD) or an electrochromatic display may be used. Alternatively, screen 420 may be a back lit display, with a light emitting source occasionally directing illumination through a pattern formed in the display. In order to obtain an appropriate image size, so that the occupants of vehicle 50 may correctly and readily read the information displayed, the character size of the display is preferably at least 5 mm. More preferably, the characters have a size of at least 7 mm, and most preferably of at least 10 mm. Screen 420 may be a multi-pixel display, a dot-matrix display, an active matrix display and/or may be a scrolling display. Alternatively, it is contemplated that screen 420 could be designed to a user's specific specifications without affecting the overall concept of the invention.

Importantly, FIG. 2. illustrates only one potential embodiment of information display 400 of the present invention, though it is contemplated that information display 400 can take on virtually any configuration without affecting the overall concept of the invention, provided that the same is capable of achieving the stated objectives of the invention as described herein. For example, it is contemplated that the computer monitors (not shown) currently onboard of many law enforcement vehicles could be modified to function as both control device 300 and information display 400 for purposes of the present invention.

As described more fully below, once an intruder's 600 presence or movement has been detected in any of zones 160, 170, 180 or 190 by any of sensors 150, proximity alert system 100 would alert occupant or officer of vehicle 50 of the same by, for example, emitting an alarm 490 and/or displaying on screen 420 the appropriate zone(s)/sensors in which said presence or movement was detected. As described above, proximity alert system 100 can also be configured so as to permit vehicle 50 occupant to selectively choose which of sensors 150 and zones 160, 170, 180, 190 to activate/deactivate at any particular time. For example, an occupant of vehicle 50 can use sensor/zone select button 450 to selectively choose which of sensors 150 and/or zones 160, 170, 180, 190 to activate or deactivate at any particular time. It is also contemplated that sensors 150 and/or zones 160, 170, 180, 190 can be activated or deactivated by a remote user using existing technology similar to that employed as part of the OnStar® system to remotely unlock a vehicle door or turn off a vehicle.

Alarm 490 can be any type of alarm known in the prior art that emits an audible message or sound when triggered. As described more fully below, alarm 490 is triggered when an intruder 600 enters any of zones 160, 170, 180 or 190 and its presence or movement is detected by any of sensors 150. In addition, or alternatively, screen 420 can be designed to flash or provide other visual indicia to an occupant of vehicle 50 when an intruder 600 enters any of zones 160, 170, 180 or 190 and its presence or movement is detected by any of sensors 150.

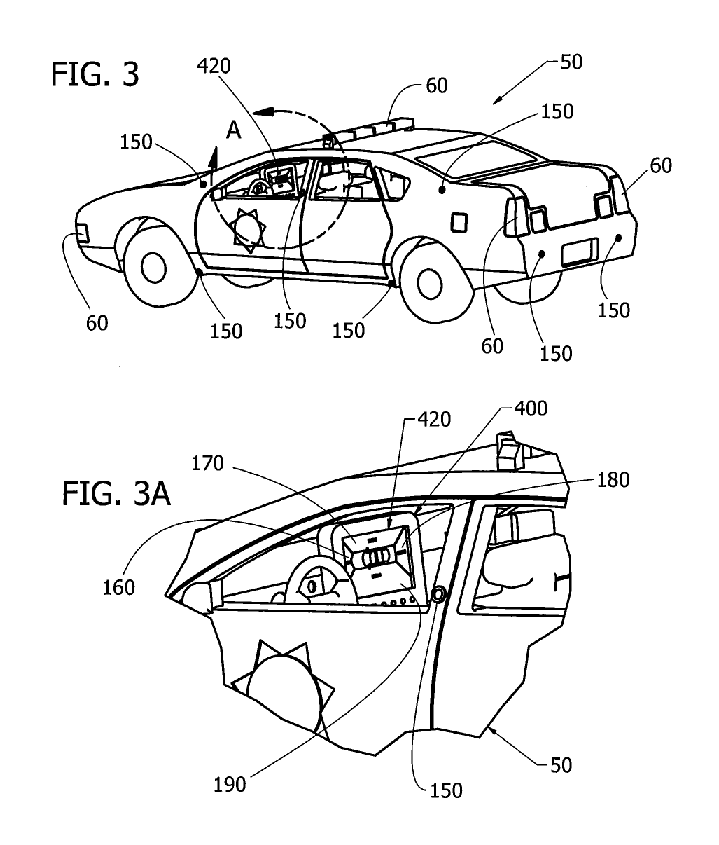

Having described the preferred composition of the SOPA system of the present invention, its operation will now be described in greater detail. FIGS. 3 and 3A depict a perspective view of a stationary law enforcement vehicle 50 with display screen 420 of proximity alert system 100 turned on in the background. For visibility purposes, the occupants of vehicle 50 are not shown. Vehicle 50 is equipped with a plurality of sensors 150 located thereon including without limitation, on the front portion 70, side portions 80 and rear portion 90 of vehicle 50.

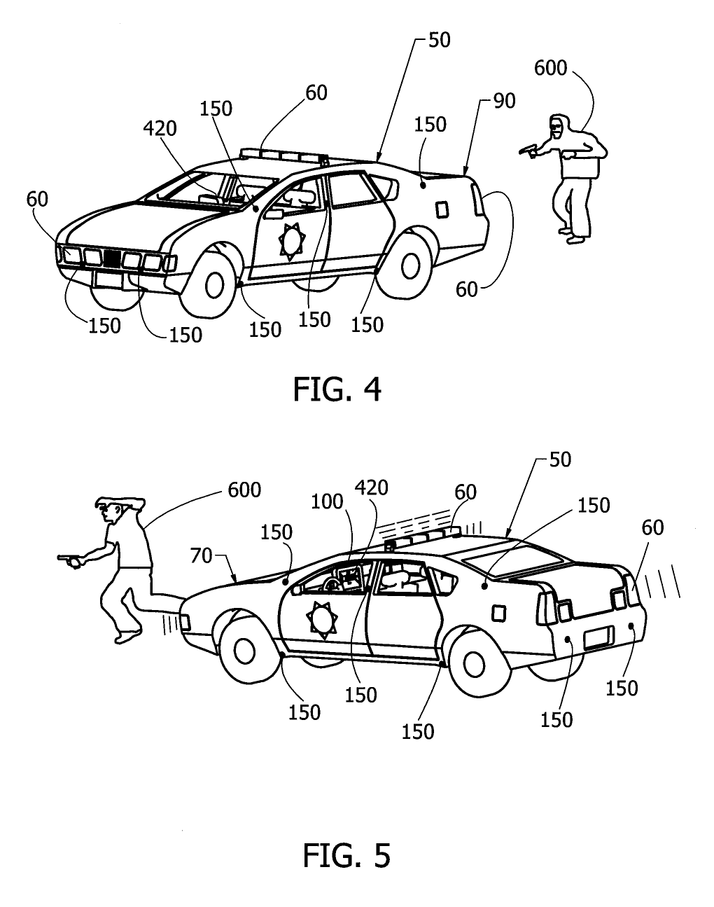

FIG. 4 depicts a perspective view of the vehicle of FIG. 3, wherein an intruder 600 approaches the rear portion 90 of vehicle 50 unbeknownst to the occupant (not shown) of vehicle 50. As intruder 600 breaches the threshold distance of at least one of the plurality of sensors 150 located on the rear portion 90 of vehicle 50, thereby entering one or more of zones 160, 170, 180, 190, said sensor 150 detects the presence of intruder 600 and sends a signal (not shown) to control device 300. Control device 300, in turn, processes the signal (not shown) and sends a signal (not shown) to information display 400 and/or a remote user (not shown) in a manner described above. Upon receipt of the signal (not shown) from control device 300, screen 420 of information display 400 alerts the occupants of vehicle 50 of the impending attack. As described above, it is also contemplated that screen 420 can advise the occupants of vehicle 50, or a remote user (not shown), of intruder's location by zone 160, 170, 180, 190 and/or sensor 150. While FIG. 2 depicts a total of four zones 160, 170, 180, 190, it is contemplated that proximity alert system 100 can be configured to provide virtually any different number or configuration of zones without affecting the overall concept of the present invention.

Remote user (not shown) can be virtually anyone interested in monitoring the perimeter of vehicle 50 including, without limitation, a dispatcher, first responder (such as another police officer, firefighter, emergency medical technician, etc.) and the like. It is anticipated that remote user can receive a signal from control device 300 by any means commonly known in the art, such as wireless communication, radio frequency technology, etc., without affecting the overall concept of the present invention.

As another important aspect of the present invention, it is also contemplated that control device 300 can trigger lights 60 and/or horn (not shown) of vehicle 50 to startle intruder 600 and/or dissuade intruder 600 from further pursuing an attack of vehicle 50 and/or its occupants. At a minimum, it is anticipated that the activation of lights 60 and/or horn (not shown) of vehicle 50 will interrupt the assault of intruder 600 and provide the occupants of vehicle 50 with a tactical advantage.

As yet a further important concept of the present invention, it is also contemplated that proximity alert system 100 can be employed while vehicle 50 is travelling at relatively low speeds (e.g., less than 20 miles per hour) to enable a law enforcement officer to monitor the perimeter of vehicle 50 while the vehicle is in motion.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A proximity alert system for a vehicle comprising:
a plurality of proximity sensors located on an exterior perimeter of the vehicle, wherein said proximity sensors are operable to detect activity within a threshold distance of said vehicle and the location of said activity relative to said vehicle;
an information display viewable by an occupant of the vehicle and operable to alert said occupant of the activity within said threshold distance and the location of said activity relative to said vehicle; and
a control device which, in response to a signal from one of said plurality of proximity sensors, is operable to (i) generate an alert to the occupant of the vehicle of the activity within said threshold distance and the location of said activity relative to said activity, and (ii) generate a response that is capable of being received outside of the vehicle.

2. The proximity alert system of claim 1, wherein said proximity alert system further comprises a power button, a sensor/zone select button, at least one sensor sensitivity button, and an alarm mute button.

3. The proximity alert system of claim 1, wherein said vehicle further comprises exterior lights and a horn and said response is comprised of at least one of the following: activation of said exterior lights, flashing exterior lights, blinking exterior lights, and activation of said horn.

4. The proximity alert system of claim 1, wherein the alert is received by a remote user of the proximity alert system.

5. The proximity alert system of claim 4, wherein said remote user is a dispatcher or a first responder.

6. The proximity alert system of claim 1, wherein said control device is a computer.

7. The proximity alert system of claim 1, wherein at least one of said plurality of proximity sensors is capable of detecting motion.

8. The proximity alert system of claim 1, wherein said information display further comprises an alphanumeric display.

9. A proximity alert system for a vehicle comprising:
a plurality of proximity sensors located on a vehicle;
a plurality of zones located in proximity to said vehicle;
an information display viewable by an occupant of the vehicle; and
a control device used to generate an alert displayable on said information display in response to a signal from one of said plurality of proximity sensors, wherein said alert informs the occupant of the particular zone from which said signal is being received.

10. The proximity alert system of claim 9, wherein said vehicle is a stationary law enforcement vehicle with exterior lights and a horn.

11. The proximity alert system of claim 10, wherein said control device is operable to generate a response that is capable of being received outside of the vehicle, wherein said response is comprised of at least one of the following: activation of said exterior lights, flashing exterior lights, blinking exterior lights, and activation of said horn.

12. The proximity alert system of claim 9, wherein the alert is received by a remote user of the proximity alert system.

13. The proximity alert system of claim 12, wherein said remote user is a dispatcher or a first responder.

14. The proximity alert system of claim 9, wherein said control device is a computer.

15. The proximity alert system of claim 9, wherein at least one of said plurality of proximity sensors is capable of detecting motion.

16. The proximity alert system of claim 9, wherein said information display further comprises an alphanumeric display.

17. A method for monitoring a perimeter of a law enforcement vehicle comprising the steps of:
using a plurality of proximity sensors installed on said law enforcement vehicle to detect an object's presence or movement in at least one of a plurality of zones around said perimeter;
detecting said object's presence or movement in said at least one of a plurality of zones around said perimeter; and
alerting an occupant of the law enforcement vehicle or a remote user of said object's presence or movement.

18. The method of monitoring a perimeter of a law enforcement vehicle of claim 17, wherein said method further comprises the step of advising said occupant or the remote user of the at least one of a plurality of zones around said perimeter in which the object's presence or movement occurred.

19. The method of monitoring a perimeter of a law enforcement vehicle of claim 17, wherein said remote user is a dispatcher or a first responder.

20. The method of monitoring a perimeter of a law enforcement vehicle of claim 17, wherein said vehicle comprises lights and a horn and wherein said method further comprises the step of activating at least one of said lights and said horn in response to said object's presence or movement.
